(19) United States
(12) Patent Application Publication
(10) Pub. No.: US 2022/0036419 A1
(43) Pub. Date: Feb. 3, 2022

(54) AUTOMATICALLY TAILORED USER EXPERIENCE FOR PRODUCT CONFIGURATION

(71) Applicant: Dell Products L.P., Round Rock, TX (US)

(72) Inventors: Irfan Gilani, Cedar Park, TX (US); Harikrishnan Nair Gopalakrishnan, Cedar Park, TX (US)

(73) Assignee: Dell Products L.P., Round Rock, TX (US)

(21) Appl. No.: 16/944,593

(22) Filed: Jul. 31, 2020

(51) Int. Cl. G06Q 30/06; G06F 17/18

(52) U.S. Cl. CPC G06Q 30/0621; G06F 17/18; G06Q 30/0643

(57) ABSTRACT

A system and method provide customized, logically-sequenced user experiences for configuring products having numbers of components and compatibility rules that have, until now, been too large for individually-customized configurators to be feasible. Embodiments analyze compatibility rules for all possible components to form a directed graph of which components affect the availability of other components in a product. This graph is then analyzed using a community detection algorithm, such as the Louvain algorithm, to identify clusters of closely-related components. Clusters as a whole are given directionality based on the directed graph of components. Then the clusters are sequenced using this directionality, so that customer configuration of components in later clusters may be affected by earlier choices, but not vice versa. Finally, the sequenced clusters are transformed into a product configuration workflow that provides a user experience similar to a custom configurator.

### FIELD

The disclosure pertains generally to electronic commerce, and more particularly to item configuration and customization during electronic shopping.

### BACKGROUND

There are two typical approaches that businesses take to enable their customers to design products and services online. The first approach is the custom configurator, in which the business creates a configuration tool for each offering in its line. This approach is only feasible for a business, such as an automobile manufacturer, that has a small number of offerings. However, it provides the most tailored end user experience during the customization process because it provides clear and concise sets of configuration actions, a logical sequence or directionality to the configuration experience, and logical grouping of small numbers of related components (e.g. all engine options on a single screen, all interior options on the next screen, and so on). While development of each custom configurator is relatively simple, the overall lifecycle costs of this approach often are high due to the need to create and maintain multiple configurators, one for each product model.

The second approach is the generic configurator, in which the business creates a configuration template that works for all (or nearly all) of its offerings. This approach is necessary for a business, such as a computer manufacturer, having too large a number of unique products or product lines for custom configurators to be feasible. Generic configurators are expensive and complex to build, but relatively simpler to maintain due to the existence of only a single user interface. Nevertheless, templated, one-size-fits-all user interfaces often are clunky, and may put all possible options for components on a single screen. This is done because it is not known how to logically sequence component configuration in groups, as is the case for custom configurators. This problem, in turn, is due to the existence of complex manufacturing or functional relationships between various components, and the particular components are not known in advance—indeed, specifying these components is a core purpose of the configuration process. While a single-screen generic configurator can highlight incompatibilities between components using compatibility rules, ultimately the end customer is left to fix the problems, resulting in a poor user experience. In some cases, correcting one incompatibility gives rise to another, making an already poor configuration experience also frustrating.

### SUMMARY OF DISCLOSED EMBODIMENTS

Disclosed embodiments provide customized, logically-sequenced user experiences for configuring products having numbers of components and compatibility rules that have, until now, been too large for individually-customized configurators to be feasible. Embodiments analyze compatibility rules for all possible components to form a directed graph of which components affect the availability of other components in a product. This graph is then analyzed using a community detection algorithm, such as the Louvain algorithm, to identify clusters of closely-related components. Clusters as a whole are given directionality based on the directed graph of components. Then the clusters are sequenced using this directionality, so that customer configuration of components in later clusters may be affected by earlier choices, but not vice versa. Finally, the sequenced clusters are transformed into a product configuration workflow that provides a user experience similar to a custom configurator.

The above-described embodiments have several advantages over the existing prior art. First, both the custom and generic configurators known in the art provide templates that are statically generated. In the custom case, there is a static, multi-screen configuration workflow that logically groups components on each screen for each of a small number of products; in the generic case, there is a static, single-screen workflow that groups all components for a large number of products. Unlike these techniques, disclosed embodiments provide a configuration workflow that is both customized and scalable. In particular, with disclosed embodiments there is no need to explicitly author user experience data to drive the configuration workflow, or to hard code a particular workflow. Rather, embodiments dynamically determine an appropriate workflow based on what groups of components need to be displayed grouped together and what sequence these groups should appear in based on an “affects relationship” between the components, as defined below. This approach offers simplicity both for the end customer and for the product provider.

Next, the user experience may be improved further using historical data regarding popular combinations of components to generate product packages that contain default components already known to be compatible. These packages may be employed to further refine and improve the detection of component clusters, and to simplify the configuration workflow, thereby improving user experience. Moreover, additional products, components, and compatibility rules may be integrated into embodiments without requiring additional software coding or data authoring, decreasing maintenance costs.

Thus, a first embodiment is a system for providing, to an individual, an automatically generated custom configurator user experience for a product, selected by the individual from a plurality of products. Each product in the plurality of products has one or more configurable components. The system includes at least an intake processor, a graph processor, and a customer interface. Some embodiments described below include other parts.

The intake processor is configured to create a directed graph, of components that are affected by the presence of other components, using assignments of components to products in the plurality of products and one or more compatibility rules. These compatibility rules are modeled into the directed graph as “affects” relations, where in the presence or selection of a component mandates the selection, or removal, or form variation of another component. This form variation can be in the fashion of quantities, slots, installation changes, or any form of variation of a given component known ahead of time.

The graph processor is configured to apply a community detection algorithm to the directed graph to thereby classify related components into clusters. These clusters are formed based on what components are closely coupled to each other based on the “affects” relationships and what are not. The graph processor is further configured to identify, for each cluster using the compatibility rules, which other clusters include components whose configurations are affected by the configurations of one or more components in that cluster, thereby determining a directionality between clusters of components.

The customer interface is configured to automatically generate the custom configurator user experience for the selected product as a sequence of configuring steps for performance by the individual, wherein the sequence has an order determined by the directionality between clusters, and wherein each configuring step requires the individual to select, for inclusion in the selected product, a component from a corresponding one of the clusters. The customer interface also is configured to provide the custom configurator user experience to the individual as an interactive user experience using a data communication network.

In some embodiments, the graph processor is configured to apply the community detection algorithm as a modularity maximization algorithm, or a minimum-cut algorithm, or a hierarchical clustering algorithm, or a statistical inference algorithm, or a clique-finding algorithm, or any combination thereof.

In some embodiments, the modularity maximization algorithm is the Louvain algorithm.

In some embodiments, the graph processor is further configured to apply historical sales data relating to the selected product to improve the classification of related components into clusters.

In some embodiments, the graph processor is further configured to apply the historical sales data to determine packages of components, and the customer interface is configured to provide one or more of the packages of components to the individual for simultaneous configuration of all of the components therein.

In some embodiments, each component is associated with one or more tags, and the graph processor names each cluster, for display to the individual, according to the most commonly occurring tag associated with components in that cluster.

In some embodiments, the customer interface is configured to provide the custom configurator user experience to the individual as a sequence of screens, one screen for each configuring step.

In some embodiments, the customer interface is further configured to update the graph processor to reflect selection of components by the individual to thereby make the community detection algorithm more efficient, or more accurate, or both.

Some embodiments also include a set of authoring tools for assigning the one or more configurable components to products in the plurality of products, or for authoring the one or more compatibility rules, or for associating each component with one or more tags, or for any combination thereof. The customer interface may be further configured to update the set of authoring tools to reflect configurations of components by the individual to thereby indicate a possible association between a configurable component and one or more tags.

Another embodiment is a method of providing, to an individual, an automatically generated custom configurator user experience for a product, selected by the individual from a plurality of products. As before, each product in the plurality of products has one or more configurable components. The method includes creating, by an intake processor, a directed graph of components that are affected by the presence of other components, using assignments of components to products in the plurality of products and one or more compatibility rules. The method also includes applying, by a graph processor, a community detection algorithm to the directed graph to thereby classify related components into clusters, and identifying, for each cluster using the compatibility rules, which other clusters include components whose configurations are affected by the configurations of one or more components in that cluster, thereby determining a directionality between clusters of components. The method further includes automatically generating, by a customer interface, the custom configurator user experience for the selected product as a sequence of configuring steps for performance by the individual, wherein the sequence has an order determined by the directionality between clusters, and wherein each configuring step requires the individual to select, for inclusion in the selected product, a component from a corresponding one of the clusters. The method finally includes providing, by the customer interface, the custom configurator user experience to the individual as an interactive user experience using a data communication network.

In some embodiments, applying the community detection algorithm comprises applying a modularity maximization algorithm, or a minimum-cut algorithm, or a hierarchical clustering algorithm, or a statistical inference algorithm, or a clique-finding algorithm, or any combination thereof.

In some embodiments, the modularity maximization algorithm is the Louvain algorithm.

Some embodiments include applying historical sales data relating to the selected product to improve the classification of related components into clusters.

In some embodiments, applying the historical sales data comprises determining packages of components, and providing the custom configurator user experience comprises providing one or more of the packages of components to the individual for simultaneous configuration of all of the components therein.

In some embodiments, each component is associated with one or more tags, and applying the community detection algorithm includes naming each cluster, for display to the individual, according to the most commonly occurring tag associated with components in that cluster.

In some embodiments, providing the custom configurator user experience to the individual includes providing a sequence of screens, one screen for each configuring step.

Some embodiments include updating the graph processor to reflect configurations of components by the individual to make the community detection algorithm more efficient, or more accurate, or both.

Some embodiments include using a set of authoring tools for defining the one or more configurable components for each product in the plurality of products, or for authoring the one or more compatibility rules, or for associating each component with one or more tags, or for any combination thereof, and updating the set of authoring tools to reflect configurations of components by the individual to further associate each component with one or more tags.

In some embodiments, the plurality of products includes a plurality of computer hardware products, or a plurality of computer accessories, or a plurality of computer software products, or any combination thereof.

In some embodiments, the configurable components of the selected product include data processing components, or data storage components, or data input/output components, or electrical power system components, or software related to the selected product, or services related to the selected product, or any combination thereof.

It is appreciated that the concepts, techniques, and structures disclosed herein may be embodied in other ways, so the above summary of embodiments should not be viewed as limiting.

### DESCRIPTION OF THE SEVERAL VIEWS OF THE DRAWINGS

The manner and process of making and using the disclosed embodiments may be appreciated by reference to the drawings, in which:

FIG. 1 schematically shows a typical client-server system in which the disclosed concepts, structures, and techniques may be advantageously embodied;

FIG. 2 schematically shows a system for providing an automatically generated custom configurator user experience for a product in accordance with a first embodiment;

FIG. 2A shows a portion of a directed graph between component clusters that may be used in connection with embodiments;

FIG. 3 shows a flowchart for a method of providing an automatically generated custom configurator user experience for a product in accordance with a second embodiment; and

FIG. 4 schematically shows relevant physical components of a computer that may be used to embody the concepts, structures, and techniques disclosed herein.

### DETAILED DESCRIPTION OF EMBODIMENTS

In this specification, including the appended claims, the following quoted terms shall have the indicated meanings that are not limited to specific embodiments, except where expressly indicated otherwise:

A “product” is any machine or manufacture having configurable types of components. For example, an automobile has an engine, a transmission, wheels, and so on as its component types. Embodiments are described herein using language relating to tangible products, however it is appreciated that processes, such as software or services for performance, also may be configured using the disclosed concepts, techniques, and structures, and that a person having ordinary skill in the art would understand how to do so without undue experimentation. Thus, except as expressly provided otherwise herein, “product” is meant to include processes and services having configurable components.

A “product configuration” is a selection, by a product customer, of one or more components for inclusion in a given product. For example, a particular automobile engine may be selected on the basis of its size or power, particular wheels may be specified on the basis that they have a particular diameter, the interior may be specified to be constructed of certain materials having a certain color, and so on.

A “package” or “model” is a selection, by a product provider, of an initial product configuration for modification by a product customer during a subsequent product configuration. For example, an automobile may come in different models, such as a coupe, sedan, SUV, and so on, that each may be offered only with a limited selection of engines, wheels, interior designs, and so on.

A “compatibility rule” is a logical rule that indicates two or more components that may or may not be compatibly used together in a product, or may be compatible only if certain criteria are met. Thus, compatibility rules constrain product configurations. For example, in an automobile, a high output power train may be compatible only with wheels having a certain minimum size—this relationship is a compatibility rule. Or, a software license may indicate that the software must be executed in a computer having at least three processors. Or, a computer provider may determine a compatibility rule that a certain processor should be sold only with a certain minimum amount of memory, even if it is operable using less memory. Compatibility rules need not be strictly based on technical limitations, but may be based on business preferences. Where the context is clear, the physical data that encode the logical rule are also referred to as the compatibility rule.

An “affects relationship” between components means component compatibility, wherein selection of one component either invalidates or mandates the selection of, or certain quantities of, the other component.

“Validation” or “build validation” is the process of ensuring that components, selected by a product customer during a product configuration, satisfy all constraints imposed by the compatibility rules for all of the components present in the selection.

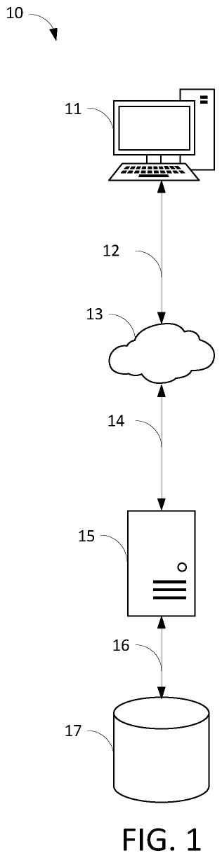

In FIG. 1 is schematically shown a typical client-server system in which the disclosed concepts, structures, and techniques may be advantageously embodied. In accordance with client-server principles, the system 10 includes at least one client device coupled for bidirectional data communication with at least one server device using a data network. Generally, the client requests, via the data network, that the server perform a computation or other function, and the server responsively fulfills the request, optionally returning a result or status indicator to the client via the data network.

Thus, the system 10 includes a client device 11. The client device 11 is illustrated as a desktop computer, but may be any electronic device known in the art, including without limitation a laptop computer, tablet computer, smartphone, embedded system, or any other device capable of transmitting and receiving data, and requesting that another electronic device perform a computation.

The client device 11 is coupled, via a data link 12, to a data network 13. The data link 12 is any combination of hardware or software suited for communicating data between the client device 11 and other electronic devices via the data network 13. The data link 12 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

The data network 13 is any combination of hardware or software suited for communicating data between electronic devices via data links. The data network 13 may be, for example, a local area network (“LAN”), a wide area network (“WAN”), a metropolitan area network (“MAN”), a virtual private network (“VPN”), the Internet, a cloud computing network, an enterprise message hub, or any other type of data network.

It is appreciated that a data network 13 operates to mediate data communication between multiple electronic devices. Thus, the depiction of only a single client device 11 in FIG. 1 is merely illustrative, and a typical system 10 may have any number of client devices coupled for data communication using corresponding data links to the data network 13. It is also appreciated that the data network 13 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

The data network 13 allows the client device 11 to communicate with a server device 15, which is coupled to the data network 13 using a data link 14. The data link 14 is any combination of hardware or software suited for communicating data between the server device 15 and other electronic devices via the data network 13. The server device 15 may be any electronic device known in the art that is capable of transmitting and receiving data, and performing a computation on behalf of another electronic device.

Again, the data network 13 operates to mediate data communication between multiple electronic devices. Thus, the depiction of only a single server device 15 in FIG. 1 is merely illustrative, and a typical system 10 may have any number of server devices coupled for data communication using corresponding data links to the data network 13. In particular, to provide simultaneous service to large numbers of client devices, a particular computation (or type of computation, such as rendering a web page) may be allocated to one of multiple server devices using a load balancer or other device. It is further appreciated that the server device 15, along with additional server devices if required, may provide well-defined operations known as “services” according to a service-oriented architecture (“SOA”), as those terms are known in the art.

It is appreciated in accordance with client-server principles that the designation of device 11 as the “client device” and device 15 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of the system 10, namely that the client device 11 is the device requesting that a particular computation be performed on behalf of a user thereof, and that the server device 15 operates a “service” to perform the computation and communicate the results to the client device 11. A typical protocol for such interaction is the Hypertext Transfer Protocol (“HTTP” or “HTTP/1.1”) specified as a proposed Internet Standard by Requests for Comment (“RFC”) 7230 through 7235, which is used to implement the World Wide Web.

FIG. 1 shows the server device 15 coupled, via a storage link 16, to a data storage device 17. The data storage device 17 may be a database, file system, volatile or non-volatile memory, network attached storage (“NAS”), storage area network (“SAN”), or any other hardware or software that is capable of storing data used by a server device 15 or a service executing thereon. The storage link 16 may be any hardware or software capable of communicating data between the server device 15 and the data storage device 17. It is appreciated that, where more than one server device 15 is present, multiple server devices may communicate with the same data storage device 17 to provide data sharing between the server devices.

It is appreciated that a requested computation may be done in several parts, thereby requiring the system 10 to retain an intermediate computational state between requests. If the services provided by the server device 15 do not store any such state (for example, to simplify their design), then the client device 11 must supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

In connection with illustrative embodiments, the computation performed by the server device 15 includes providing an electronic shopping function for an individual using the client device 11. This electronic shopping function has an automatically tailored user experience for configuration of products for sale, as described below.

Components provide functions to products. For instance, a computer (product) may have a central processing unit (component type), a volatile memory (component type), a non-volatile data store (component type), and a power supply (component type), among many other types of components. It is well known that many components may exist that implement the functions of any given component type. Thus, CPU components having a wide array of different capabilities are manufactured by many different vendors, as are RAM chips, hard drives, power supplies, and other types of computer components. However, it is also well known that some components are only compatible with certain other components. In this connection, a CPU that expects a certain input voltage on its power lead is only compatible with circuitry that provides that input voltage, a memory that expects to be driven by clock pulses no faster than a certain rate must be coupled to circuitry that provides an appropriate clock signal, and so on. Compatibility rules capture these relationships. A compatibility rule may specify, for each component, a list of other components with which the given component is (or is not) compatible in a manufacturable product or a deliverable service, and may reflect technical interoperability, business preferences, or both.

Products that may be beneficially configured in accordance with disclosed embodiments thus include computer products such as computer hardware products, computer accessories, and computer software products. The components of these products that may be individually configured include data processing components, data storage components, data input/output components, electrical power system components, and even related services such as warranties. It is appreciated, however, that embodiments of the concepts, techniques, and structures disclosed herein may be used to configure many other products having configurable components, and the description herein of the configuration of computer products should not be viewed as limiting.

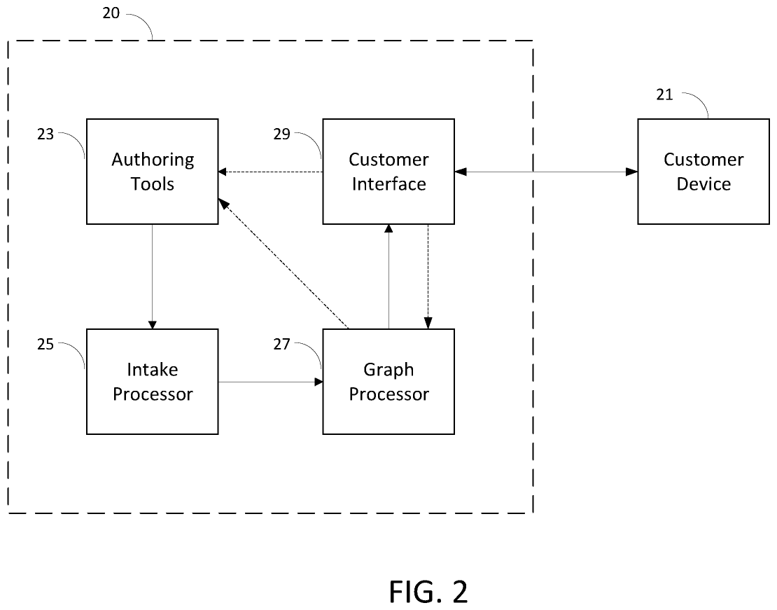

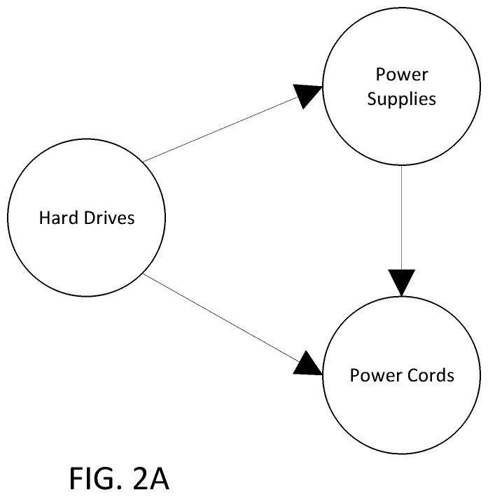

Thus, in FIG. 2 is schematically shown a system 20 for providing an automatically generated custom configurator user experience for a product to a customer device 21 in accordance with a first embodiment. The customer device 21 illustratively may be implemented as the client device 11 of FIG. 1, while the system 20 may be implemented as the server device 15 and data storage device 17, or by several servers and data storage devices as described in more detail below. The system 20 includes authoring tools 23 (which may be optional, as described below), an intake processor 25, a graph processor 27, and a customer interface 29. Each of these components of the system 20 likewise may be implemented by one or more servers and one or more data storage devices (not shown for simplicity). It is appreciated that the functions illustrated in FIG. 2, and their relationships within the system 20, may be embodied in other ways, and that in this regard FIG. 2 is merely illustrative and should not be viewed as limiting.

The authoring tools 23 are administrative tools for use by a product provider to create product data, including without limitation: defining products having one or more configurable components, assigning these components to products, defining compatibility rules between the components, or specifying part numbers or other attributes of components, including semantic “tags” that may describe their properties or name them. Some of these functions are described below in more detail, especially semantic tagging. The above list of functions is meant to be illustrative rather than comprehensive, and it is appreciated that persons having ordinary skill in the art may understand additional functions that may be provided by the authoring tools 23.

The authoring tools 23 may use two databases of relevance to disclosed embodiments. The first database stores relationships between products and their components, and in particular which components may be found within which products. The second database stores compatibility rules that define “affects” relationships between various components. The databases used by the authoring tools 23 may have any data storage format known in the art. In various embodiments, the authoring tools 23 may be omitted if the intake processor, described below, has access to these two databases. This may be the case, for example, if product and compatibility rules databases are provided by a parts vendor or supplier, rather than the provider of the saleable product.

The intake processor 25 creates a directed graph of components that are affected by the presence of other components. It does this using assignments of components to products from the first database just described, and compatibility rules between components from the second database. In typical embodiments, the intake processor 25 has two subsystems, namely adaptors and schema translators.

Adaptors in the intake processor 25 are functional components that read product data and compatibility rules data from their respective databases and convert these data into a form suitable for subsequent computation by the graph processor 27 described below. Adaptors may be necessary because the databases used by the authoring tools may have any storage format known in the art. Thus, there may be an adaptor for use with the product database, and a separate adaptor for use with the compatibility rules database. Alternately, a single adaptor may be used.

Each adaptor may be designed to process messages from the authoring tools 23, if present, that indicate data in its respective database has been updated. In response to such messages, the adaptor may responsively perform its conversion function on the new data and trigger generation of a new directed graph as described below. Alternately or in addition, each adaptor may be designed to execute in a batched mode only after receipt of many such messages, for example at regular times or regular intervals. This mode of operation may be necessary when the product and compatibility rules databases are provided by a third party.

Schema translators in the intake processor 25 receive the converted, computationally-friendly product and compatibility rules data, and translate them into a format or schema designed for efficient use by graph theoretical algorithms using in the graph processor 27. Schema translators use common techniques like data mapping and serialization to perform this function. The schema translators combine the product and compatibility rules data into one or more directed graphs. This is done by forming graphs whose nodes are all of the configurable component types in the product data, and whose edges are directed from a component type to another component type when configuration or selection of a component of the first type affects configuration of components of the second type, as determined by the compatibility rules data. The graphs may be encoded as data in any useful format, and stored in a conventional database.

A first technique forms a single graph in which each component is a node, and compatibility rules between components give rise to directed edges based on “affects relationships”, where the edge is directed from the affecting component to the affected component in the relationship. In this case, product configuration represents selection of a particular subgraph.

A second technique forms several graphs in a graph database, one for each product. The particular components that appear as nodes in each graph are determined by external data, such as the product-component database described above. The compatibility rules that give rise to the directed edges may be specified, not just on a component-to-component basis, but also as a function of the particular product in which the components appear.

A third technique uses multiple graphs to form the configuration user experience. A product provider may specify a manufacturing and sales hierarchy, i.e. first one chooses a brand, then a product family, then a particular product. This hierarchy itself may be represented as a directed graph having products and compatibility rules between them. These compatibility rules may be global, or only applicable at one of the levels of the hierarchy.

Various means for storing graphs may be used. For example, graphs formed according to any of the above techniques may be partitioned for efficient storage. It is appreciated that storage techniques may be optimized on the basis of the particular method of forming the graph or graphs, and that methods other than those just described may be used to embody the concepts and techniques described herein.

Selection of a particular product for configuration entails selection of a subgraph of the directed graph, namely the subgraph indicating compatibility rules data for those components that may appear in the selected product. Selection of different products entails selection of different subgraphs from a single, potentially very large directed graph of component relationships.

The graph processor 27 is responsible for detecting clusters within the one or more graphs. The graph processor 27 operates by applying one or more community detection algorithms (i.e. cluster detection algorithms) to the directed graph created by the intake processor 25, to thereby classify related components into clusters. Any clustering algorithms known in the art may be used, including modularity maximization (such as the Louvain method), minimum-cut, hierarchical clustering, statistical inference, clique-finding, and others. It is appreciated that different algorithms produce slightly varying results on different types of data sets, so the use of a combination of algorithms permits the graph processor 27 to determine the best algorithm for a given data set.

Which algorithm or combination is “best” may be measured using typical clustering metrics, including distance connectivity, statistical density of nodes in a data space, edge connectivity dimension, and others known in the art. Alternately or in addition, the choice of algorithm(s) may be suggested or selected by domain or subject matter experts using additional information, such as historical sales data. Thus, in some embodiments, the graph processor 27 uses machine learning to identify a “best guess” algorithm or combination for a given dataset, and this guess is reviewed by the subject matter experts. The graph processor 27 writes the output clusters to a repository or database for consumption by the customer interface 29 described below.

The graph processor 27 further operates to determine a directionality between clusters of components. While the compatibility rules determine a directionality of “affects” relationships between individual components, the graph processor 27 transplants this notion to clusters as a whole, since the selection of a component within a cluster may affect which components are available for selection in another cluster. Recall the example of configuring an automobile to have a high output drive train that requires wheels having a certain diameter. In this example, the selection of a particular drive train (from a cluster of drive train components) affects which wheels may be selected (from a cluster of wheel components). Therefore, configuring the drive train cluster, as a whole, affects later configuring the wheel cluster, as a whole. This is an example of a cluster-to-cluster “affects” relationship that the graph processor 27 determines to be a directionality between the two clusters.

As a further example, the choice of a particular hard drive for inclusion in a computer affects both the choice of the computer's power supply and the choice of its power cords. Moreover, the choice of power supply may affect the choice of power cords. Thus, the directed graph containing these three types of components in an embodiment would have a node each for “hard drives”, “power supplies”, and “power cords”. And the graph would have edges pointing from “hard drives” to both “power supplies” and “power cords”, and a third edge pointing from “power supplies” to “power cords”. This portion of the directed graph is shown illustratively in FIG. 2A.

In an actual computer product configuration, there would be many more types of components and compatibility relations between them, and the directed graph accordingly would have many more nodes and edges. This large number of component types and compatibility relationships has prevented custom configurators from being used in connection with computer component selection, as well as configuration of many other products and services such as automobiles from makers who have large numbers of models, data hosting services, big-box retail products, and so on.

As may be expected, certain product configurations are more popular than others. For example, in the computer realm, competitive gamers may require high-end graphics processors and low-latency network interface cards, while light users who just check email and browse the Internet may not need particularly high-end components, and enterprise users may require a fast CPU with multiple cores and fast input/output devices but low-end graphics components. On a more granular level, each component itself may be manufactured from sub-components. For example, a convertible roof in an automobile is made of components like an open/close slider switch, a top cover, a storage compartment, a motor, connecting wires, and so on. In both cases, the end customer may not be interested in configuring each component separately, but may instead wish to select all of these components as a package. And previous customers (or the product provider itself) may have already determined configurations of components that meet various end customer needs, and may have already gone through the process of ensuring that these configurations satisfy all of the component compatibility rules.

In some embodiments, the graph processor 27 uses these insights about component packages to perform additional processing, thereby improving its classification of related components into clusters. Each of pre-validated package configuration may be identified as its own cluster of components by the graph processor 27, and in particular by overlaying historical sales data onto the directed graph to weight various nodes and edges, then applying one or more of the built-in community detection algorithms. Illustratively, a large group of components may be automatically configured merely by an automobile customer selecting a “convertible” option, and this group of components is always configured together in the saleable product. This is just the sort of situation in which community detection algorithms are particularly effective at determining clusters of items. Or, these sales data may be used to determine clusters where “affects” relationships alone are insufficient to group components tightly enough for the chosen clustering algorithm or combination of algorithms to determine on its own.

It is appreciated that various weighting strategies may be employed to determine components that belong to a single package, and that such strategies would be known to a person having ordinary skill in the art, as would be an understanding of how to pick and apply an appropriate strategy. It is also appreciated that the historical sales data may be obtained from any suitable data source, such as a sales database, and that the intake processor 25 may include adaptors and schema translators suitable for extracting these data and converting them into a format useful for carrying out the concepts of the above discussion.

In the computer realm, the various packages might be labeled by the target audience, i.e. “gamer” or “light user” or “enterprise user” as appropriate. That is, gamers as a group might tend to prefer certain combinations of components that are different than those preferred by light users or enterprise users. Thus, identifying a particular package of interest to the customer may suggest a pre-defined set of configured options, rather than offering all of the components for individual configuration. The existence of these packages, and their determination by the graph processor 27, may further serve to improve the classification of related components into clusters.

In some embodiments, the graph processor 27 performs additional processing to assist the customer interface 29 in providing the custom configurator user experience to the end customer. In particular, the graph processor may attempt to attach a name to each cluster to assist the customer with understanding how components in each cluster are related to each other. If each component is associated with a tag (e.g. “CPU”, “memory”, “storage” etc.) then the graph processor 27 may choose a name from among the tags. However, tags may capture any meaning, at any level of generality, and it is not known prior to clustering which components will be clustered together. Thus, in some embodiments, the graph processor assigns to each cluster a name, for display to the customer, according to the most commonly occurring tag associated with components in that cluster. Thus, clusters are named according to the granularity at which the clustering algorithm determines is best. It is appreciated that the tags may be obtained from any suitable data source, such as a tag database associated with one of the authoring tools 23, and that the intake processor 25 may include adaptors and schema translators suitable for extracting these data and converting them into a format useful for carrying out the concepts of the above discussion.

The customer interface 29 generates and provides the custom configurator user experience to the end customer device 21 as a workflow using a rendering platform. In particular, the customer interface 29 automatically generates the custom configurator user experience for the selected product as a sequence of configuring steps for performance by the individual. The sequence has an order determined by the directionality between clusters, and each configuring step requires the individual to select a component from a corresponding one of the clusters for inclusion in the selected product. Thus, the custom configurator user experience in accordance with embodiments logically groups related component options together.

Custom configurator user experience embodiments, moreover, logically sequence these clusters so that dependencies between components are resolved throughout in the configuration process without backtracking. That is, the sequence of configuring steps is determined so that component validation advantageously can be performed incrementally, rather than monolithically. In particular, disclosed embodiments prevent potential frustration by end customers at being forced to hunt down all component incompatibilities using a generic configurator.

The format of the custom configurator user experience may be determined by the needs of the product provider. In some embodiments, the custom configurator user experience may be provided as a sequence of screens, one screen for each configuring step. These screens may be implemented, for example, as a sequence of web pages for display in a browser on the customer device 21, or as a single web page having a sequence of “tabbed” or otherwise navigable subpages or frames, or as a sequence of screens within a app executing in the customer device 21, or in other ways known in the art for presenting sequential workflows.

The graph processor 27 of some embodiments may further name each cluster for display to the customer, and this name may be presented as a title on each screen or tab. This name may be derived from the tags of the components within the cluster. Illustratively, if the components are (say) a motherboard, CPU, and additional processors, all of which are tagged “processing”, then the cluster name might be rendered as “processing capacity”. Or, if the components are hard drives, solid state drives, and power supplies the majority of which are tagged “storage”, then the cluster name might be rendered as “storage capacity”. It is expected that a person of ordinary skill in the art will appreciate how to apply these techniques to other components having different tags.

The customer interface 29 then provides the custom configurator user experience, so generated, to the customer as an interactive user experience using a data communication network. Depending on the format of the custom configurator user experience and how it is accessed, these data may be provided to the customer device 21 as hypertext markup language (HTML), extensible markup language (XML), JavaScript™ object notation (JSON), or other suitable data interchange format known in the art. It is appreciated that a person having ordinary skill in the art will appreciate how to design a protocol for the exchange of these data between the customer interface 29 and the customer device 21. To this end, the customer interface 29 may be implemented by a collection of web servers or similar technology.

The customer interface 29 may update the graph processor 27 to reflect selection of components by the customer. As discussed above, such selections are useful in connection with determining component packages, and thus may be used to make the community detection algorithm more efficient, or more accurate, or both. Unlike the above discussion, however, the customer interface 29 may update the graph processor directly in response to customer feedback, rather than relying on historical sales data. Common messaging technologies can be used for this purpose.

The customer interface 29 also may update the set of authoring tools 23 to enhance tagging and clustering behaviors. In particular, the authoring tools 23 may be updated to reflect configurations of components by the customer that indicate a possible association between a configurable component and one or more semantic tags. Common messaging technologies can be used for this purpose as well.

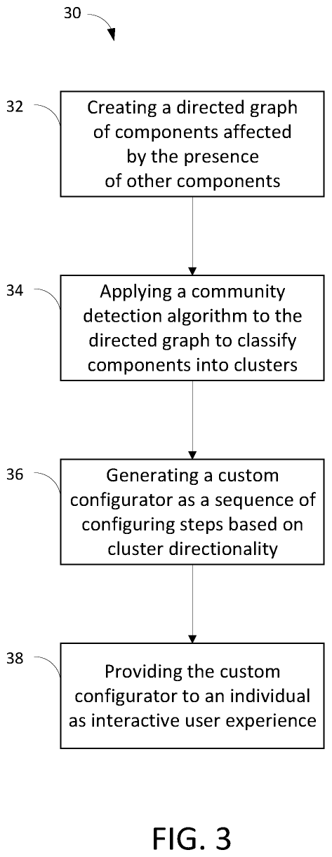

FIG. 3 shows a flowchart for a method 30 of providing an automatically generated custom configurator user experience for a product. The method 30 may be performed by a server device 15 and data storage device 17 on behalf of a customer using a client device 11, as shown in FIG. 1, or by a collection of server devices, or a collection of data storage devices, or a combination of these. The method 30 may be performed using the system 20, or using a computer system or other automated technology capable of performing the processes now described.

The method 30 begins with a process 32 of creating a directed graph of components that are affected by the presence of other components. The directed graph is created using assignments of components to products, and one or more compatibility rules between those components. The creating process 32 illustratively may be performed by the intake processor 25 as described above.

The method 30 continues with a process 34 of applying a community detection algorithm to the directed graph to thereby classify related components into clusters. As indicated above, the community detection algorithm may be a modularity maximization algorithm, such as the Louvain algorithm, or a minimum-cut algorithm, or a hierarchical clustering algorithm, or a statistical inference algorithm, or a clique-finding algorithm, as those techniques are known in the art, or it may be any combination thereof. It is appreciated that other algorithms suitable for community detection may yet be developed, but that a person having ordinary skill in the art will understand how to include such algorithms into the process 34 without undue experimentation.

The process 34 also includes identifying, for each cluster using the compatibility rules, which other clusters include components whose configurations are affected by the configurations of one or more components in that cluster, thereby determining a directionality between clusters of components. The classification of related components into clusters, provided by process 34, may be improved by applying historical sales data. In particular, if the historical sales data indicate that certain components are usually chosen together as a package, that package may be identified as an option for selecting all of those components together, during (and to simplify) the custom configurator user experience. And if components are associated with one or more tags, the process 34 may include naming each cluster according to the most commonly occurring tag associated with components in that cluster. The applying process 34 illustratively may be performed by the graph processor 27 as described above.

The method 30 continues with a process 36 of automatically generating a custom configurator user experience as a sequence of configuring steps. The sequence has an order determined by the directionality between clusters, as identified by the process 34. Each configuring step requires the individual to select, for inclusion in the selected product, a component from a corresponding one of the clusters. In this way, a selected product is completely configured after all configuring steps have been completed. The process 36 illustratively may be performed by the customer interface 29 as described above.

The method 30 concludes with a process 38 of providing the custom configurator user experience to the customer as an interactive user experience. As noted above, presentation of the configuration can be as a sequence of screens, one screen for each configuring step. Such presentation includes, without limitation: web pages that each correspond to a cluster, or a single web page having multiple tabs that each correspond to a cluster, or screens provided by a downloadable app. The process 38 illustratively may be performed by the customer interface 29 as described above.

The method 30 optionally includes various feedback processes described above. Thus, the method 30 may include making the community detection algorithm more efficient, or more accurate, or both, by updating the directed graph to reflect selection of components by the customer. Alternately or in addition, the method may include using a set of authoring tools, such as the authoring tools 23, for defining the one or more configurable components for each product in the plurality of products, or for authoring the one or more compatibility rules, or for associating each component with one or more tags, or for any combination thereof. If authoring tools are used, another feedback process may update those tools to reflect configurations of components by the individual to further associate each component with one or more tags, thereby providing more accurate tagging of identified clusters.

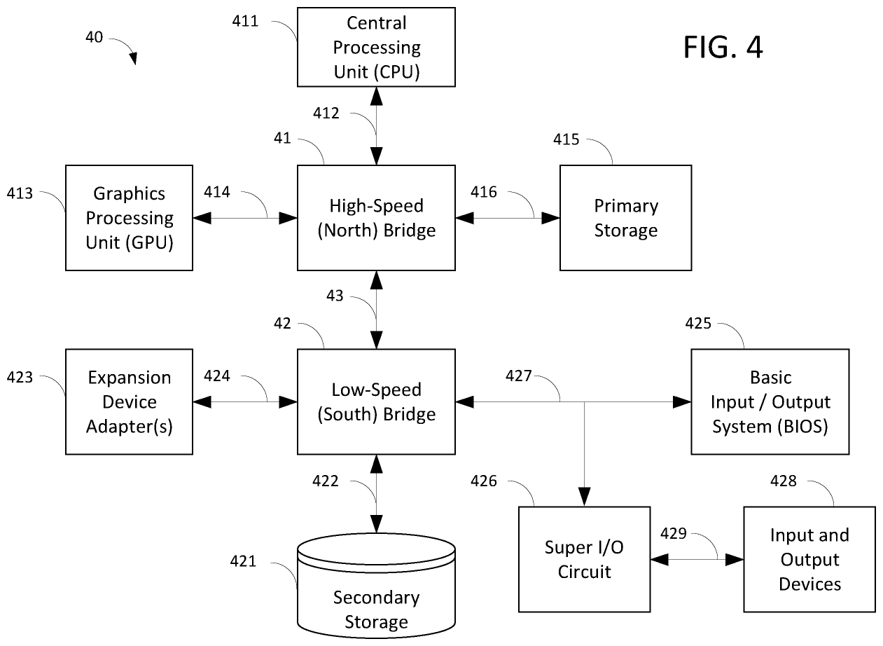

FIG. 4 schematically shows relevant physical components of a computer 40 that may be used to embody the concepts, structures, and techniques disclosed herein. In particular, the computer 40 may be used to implement, in whole or in part: the client device 11, the server device 15, the data storage device 17, the system 20 or any of its components (authoring tools 23, intake processor 25, graph processor 27, or customer interface 29), the customer device 21, or any or all of the method 30. Generally, the computer 40 has many functional components that communicate data with each other using data buses. The functional components of FIG. 4 are physically arranged based on the speed at which each must operate, and the technology used to communicate data using buses at the necessary speeds to permit such operation.

Thus, the computer 40 is arranged as high-speed components and buses 411 to 416 and low-speed components and buses 421 to 429. The high-speed components and buses 411 to 416 are coupled for data communication using a high-speed bridge 41, also called a “northbridge,” while the low-speed components and buses 421 to 429 are coupled using a low-speed bridge 42, also called a “southbridge.”

The computer 40 includes a central processing unit (“CPU”) 411 coupled to the high-speed bridge 41 via a bus 412. The CPU 411 is electronic circuitry that carries out the instructions of a computer program. As is known in the art, the CPU 411 may be implemented as a microprocessor; that is, as an integrated circuit (“IC”; also called a “chip” or “microchip”). In some embodiments, the CPU 411 may be implemented as a microcontroller for embedded applications, or according to other embodiments known in the art.

The bus 412 may be implemented using any technology known in the art for interconnection of CPUs (or more particularly, of microprocessors). For example, the bus 412 may be implemented using the HyperTransport architecture developed initially by AMD, the Intel QuickPath Interconnect (“QPI”), or a similar technology. In some embodiments, the functions of the high-speed bridge 41 may be implemented in whole or in part by the CPU 411, obviating the need for the bus 412.

The computer 40 includes one or more graphics processing units (GPUs) 413 coupled to the high-speed bridge 41 via a graphics bus 414. Each GPU 413 is designed to process commands from the CPU 411 into image data for display on a display screen (not shown). In some embodiments, the CPU 411 performs graphics processing directly, obviating the need for a separate GPU 413 and graphics bus 414. In other embodiments, a GPU 413 is physically embodied as an integrated circuit separate from the CPU 411 and may be physically detachable from the computer 40 if embodied on an expansion card, such as a video card. The GPU 413 may store image data (or other data, if the GPU 413 is used as an auxiliary computing processor) in a graphics buffer.

The graphics bus 414 may be implemented using any technology known in the art for data communication between a CPU and a GPU. For example, the graphics bus 414 may be implemented using the Peripheral Component Interconnect Express (“PCI Express” or “PCIe”) standard, or a similar technology.

The computer 40 includes a primary storage 415 coupled to the high-speed bridge 41 via a memory bus 416. The primary storage 415, which may be called “main memory” or simply “memory” herein, includes computer program instructions, data, or both, for use by the CPU 411. The primary storage 415 may include random-access memory (“RAM”). RAM is “volatile” if its data are lost when power is removed, and “non-volatile” if its data are retained without applied power. Typically, volatile RAM is used when the computer 40 is “awake” and executing a program, and when the computer 40 is temporarily “asleep”, while non-volatile RAM (“NVRAM”) is used when the computer 40 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 416 may be implemented using any technology known in the art for data communication between a CPU and a primary storage. The memory bus 416 may comprise an address bus for electrically indicating a storage address, and a data bus for transmitting program instructions and data to, and receiving them from, the primary storage 415. For example, if data are stored and retrieved 64 bits (eight bytes) at a time, then the data bus has a width of 64 bits. Continuing this example, if the address bus has a width of 32 bits, then 2³² memory addresses are accessible, so the computer 40 may use up to 8*2³²=32 gigabytes (GB) of primary storage 415. In this example, the memory bus 416 will have a total width of 64+32=96 bits. The computer 40 also may include a memory controller circuit (not shown) that converts electrical signals received from the memory bus 416 to electrical signals expected by physical pins in the primary storage 415, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 411, the graphics processing units 413, the primary storage 415, and the high-speed bridge 41, or any combination thereof, as a single integrated circuit. In such embodiments, buses 412, 414, 416 may form part of the same integrated circuit and need not be physically separate. Other designs for the computer 40 may embody the functions of the CPU 411, graphics processing units 413, and the primary storage 415 in different configurations, obviating the need for one or more of the buses 412, 414, 416.

The depiction of the high-speed bridge 41 coupled to the CPU 411, GPU 413, and primary storage 415 is merely exemplary, as other components may be coupled for communication with the high-speed bridge 41. For example, a network interface controller (“NIC” or “network adapter”) may be coupled to the high-speed bridge 41, for transmitting and receiving data using a data channel. The NIC may store data to be transmitted to, and received from, the data channel in a network data buffer.

The high-speed bridge 41 is coupled for data communication with the low-speed bridge 42 using an internal data bus 43. Control circuitry (not shown) may be required for transmitting and receiving data at different speeds. The internal data bus 43 may be implemented using the Intel Direct Media Interface (“DMI”) or a similar technology.

The computer 40 includes a secondary storage 421 coupled to the low-speed bridge 42 via a storage bus 422. The secondary storage 421, which may be called “auxiliary memory”, “auxiliary storage”, or “external memory” herein, stores program instructions and data for access at relatively low speeds and over relatively long durations. Since such durations may include removal of power from the computer 40, the secondary storage 421 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 422 may be implemented using any technology known in the art for data communication between a CPU and a secondary storage and may include a host adaptor (not shown) for adapting electrical signals from the low-speed bridge 42 to a format expected by physical pins on the secondary storage 421, and vice versa. For example, the storage bus 422 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 40 also includes one or more expansion device adapters 423 coupled to the low-speed bridge 42 via a respective one or more expansion buses 424. Each expansion device adapter 423 permits the computer 40 to communicate with expansion devices (not shown) that provide additional functionality. Such additional functionality may be provided on a separate, removable expansion card, for example an additional graphics card, network card, host adaptor, or specialized processing card.

Each expansion bus 424 may be implemented using any technology known in the art for data communication between a CPU and an expansion device adapter. For example, the expansion bus 424 may transmit and receive electrical signals using a Peripheral Component Interconnect (“PCI”) standard, a data networking standard such as an Ethernet standard, or a similar technology.

The computer 40 includes a basic input/output system (“BIOS”) 425 and a Super I/O circuit 426 coupled to the low-speed bridge 42 via a bus 427. The BIOS 425 is a non-volatile memory used to initialize the hardware of the computer 40 during the power-on process. The Super I/O circuit 426 is an integrated circuit that combines input and output (“I/O”) interfaces for low-speed input and output devices 428, such as a serial mouse and a keyboard. In some embodiments, BIOS functionality is incorporated in the Super I/O circuit 426 directly, obviating the need for a separate BIOS 425.

The bus 427 may be implemented using any technology known in the art for data communication between a CPU, a BIOS (if present), and a Super I/O circuit. For example, the bus 427 may be implemented using a Low Pin Count (“LPC”) bus, an Industry Standard Architecture (“ISA”) bus, or similar technology. The Super I/O circuit 426 is coupled to the I/O devices 428 via one or more buses 429. The buses 429 may be serial buses, parallel buses, other buses known in the art, or a combination of these, depending on the type of I/O devices 428 coupled to the computer 40.

The techniques and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system for providing, to an individual, an automatically generated custom configurator user experience for a product, selected by the individual from a plurality of products, each product in the plurality of products having one or more configurable components, the system comprising:
an intake processor configured to create a directed graph, of components that are affected by the presence of other components, using assignments of components to products in the plurality of products and one or more compatibility rules;
a graph processor configured to apply a community detection algorithm to the directed graph to thereby classify related components into clusters, and to identify, for each cluster using the compatibility rules, which other clusters include components whose configurations are affected by the configurations of one or more components in that cluster, thereby determining a directionality between clusters of components; and
a customer interface configured to automatically generate the custom configurator user experience for the selected product as a sequence of configuring steps for performance by the individual, wherein the sequence has an order determined by the directionality between clusters, and wherein each configuring step requires the individual to select, for inclusion in the selected product, a component from a corresponding one of the clusters;
the customer interface further configured to provide the custom configurator user experience to the individual as an interactive user experience using a data communication network.

2. The system according to claim 1, wherein the graph processor is configured to apply the community detection algorithm as a modularity maximization algorithm, or a minimum-cut algorithm, or a hierarchical clustering algorithm, or a statistical inference algorithm, or a clique-finding algorithm, or any combination thereof.

3. The system according to claim 2, wherein the modularity maximization algorithm is the Louvain algorithm.

4. The system according to claim 1, wherein the graph processor is further configured to apply historical sales data relating to the selected product to improve the classification of related components into clusters.

5. The system according to claim 4, wherein the graph processor is further configured to apply the historical sales data to determine packages of components, and wherein the customer interface is configured to provide one or more of the packages of components to the individual for simultaneous configuration of all of the components therein.

6. The system according to claim 1, wherein each component is associated with one or more tags, and wherein the graph processor names each cluster, for display to the individual, according to the most commonly occurring tag associated with components in that cluster.

7. The system according to claim 1, wherein the customer interface is configured to provide the custom configurator user experience to the individual as a sequence of screens, one screen for each configuring step.

8. The system according to claim 1, wherein the customer interface is further configured to update the graph processor to reflect selection of components by the individual to thereby make the community detection algorithm more efficient, or more accurate, or both.

9. The system according to claim 1, further comprising a set of authoring tools for assigning the one or more configurable components to products in the plurality of products, or for authoring the one or more compatibility rules, or for associating each component with one or more tags, or for any combination thereof, wherein the customer interface is further configured to update the set of authoring tools to reflect configurations of components by the individual to thereby indicate a possible association between a configurable component and one or more tags.

10. A method of providing, to an individual, an automatically generated custom configurator user experience for a product, selected by the individual from a plurality of products, each product in the plurality of products having one or more configurable components, the method comprising:
creating, by an intake processor, a directed graph of components that are affected by the presence of other components, using assignments of components to products in the plurality of products and one or more compatibility rules;
applying, by a graph processor, a community detection algorithm to the directed graph to thereby classify related components into clusters, and identifying, for each cluster using the compatibility rules, which other clusters include components whose configurations are affected by the configurations of one or more components in that cluster, thereby determining a directionality between clusters of components;
automatically generating, by a customer interface, the custom configurator user experience for the selected product as a sequence of configuring steps for performance by the individual, wherein the sequence has an order determined by the directionality between clusters, and wherein each configuring step requires the individual to select, for inclusion in the selected product, a component from a corresponding one of the clusters; and
providing, by the customer interface, the custom configurator user experience to the individual as an interactive user experience using a data communication network.

11. The method according to claim 10, wherein applying the community detection algorithm comprises applying a modularity maximization algorithm, or a minimum-cut algorithm, or a hierarchical clustering algorithm, or a statistical inference algorithm, or a clique-finding algorithm, or any combination thereof.

12. The system according to claim 11, wherein the modularity maximization algorithm is the Louvain algorithm.

13. The method according to claim 10, further comprising applying historical sales data relating to the selected product to improve the classification of related components into clusters.

14. The method according to claim 13, wherein applying the historical sales data comprises determining packages of components, and providing the custom configurator user experience comprises providing one or more of the packages of components to the individual for simultaneous configuration of all of the components therein.

15. The method according to claim 10, wherein each component is associated with one or more tags, and wherein applying the community detection algorithm includes naming each cluster, for display to the individual, according to the most commonly occurring tag associated with components in that cluster.

16. The method according to claim 10, wherein providing the custom configurator user experience to the individual includes providing a sequence of screens, one screen for each configuring step.

17. The method according to claim 10, further comprising updating the graph processor to reflect selection of components by the individual to make the community detection algorithm more efficient, or more accurate, or both.

18. The method according to claim 10, further comprising:
using a set of authoring tools for defining the one or more configurable components for each product in the plurality of products, or for authoring the one or more compatibility rules, or for associating each component with one or more tags, or for any combination thereof; and
updating the set of authoring tools to reflect configurations of components by the individual to further associate each component with one or more tags.

19. The method according to claim 10, wherein the plurality of products includes a plurality of computer hardware products, or a plurality of computer accessories, or a plurality of computer software products, or any combination thereof.

20. The method according to claim 10, wherein the configurable components of the selected product include data processing components, or data storage components, or data input/output components, or electrical power system components, or software related to the selected product, or services related to the selected product, or any combination thereof.
